(19) United States
(12) Patent Application Publication
(10) Pub. No.: US 2024/0383182 A1
(43) Pub. Date: Nov. 21, 2024

(54) INJECTION MOLDING METHODS AND SYSTEMS FOR COMPONENT ROTATIONAL ADJUSTMENTS

(71) Applicant: GM GLOBAL TECHNOLOGY OPERATIONS LLC, Detroit, MI (US)

(72) Inventors: Adam L Wright, Livonia, MI (US); Nathaniel W Hart, Beverly Hills, MI (US); David Francis Miller, Bloomfield Hills, MI (US)

(73) Assignee: GM GLOBAL TECHNOLOGY OPERATIONS LLC, Detroit, MI (US)

(21) Appl. No.: 18/320,854

(22) Filed: May 19, 2023

(51) Int. Cl. B29C 45/80

(52) U.S. Cl. CPC B29C 45/80; B29C 2945/76083; B29C 2945/76257; B29C 2945/76464; B29C 2945/76568; B29C 2945/76735

(57) ABSTRACT

Component manufacturing methods and systems and methods are provided for six degree of freedom control of a component prior to molding. A method involves obtaining measurement data from a measurement device indicative of a measured orientation of a component mounted to a surface of a tool associated with a molding assembly, determining an orientation adjustment based on a relationship between the measured orientation of the component and a reference orientation associated with the molding assembly, determining an actuation command for operating an actuation arrangement coupled to the tool based at least in part on the orientation adjustment, and providing the actuation command to the actuation arrangement to actuate the tool to rotate the surface in accordance with the orientation adjustment prior to forming a molding compound on an exposed surface of the component using the molding assembly.

### INTRODUCTION

The technical field generally relates to vehicle systems and more particularly relates to orientation corrections prior to injection molding devices for vehicle systems.

Many vehicles rely on various components to support vehicle operations. Modern vehicle systems may employ various optical device to support vehicle operations, such as, for example, optical sensors, ranging sensors, image sensors and/or the like. Molding, such as injection molding, is often employed to provide components with the desired structure and support while also protecting the molded components from environmental conditions. Component tolerances and other variations associated with manufacture and assembly of components can lead to corresponding variations, deformations, distortions or other inconsistencies in the molding of those components, which, in turn, can impair performance of various aspects or elements of those components (e.g., optical elements), and thereby, increase costs and/or reduce yield.

### SUMMARY

Apparatus for injection molding and related methods and systems for orientation corrections using the same are provided. One method involves obtaining, by a control module, measurement data from a measurement device indicative of a measured orientation of a component mounted to a surface of a tool associated with a molding assembly, determining, by the control module, an orientation adjustment based on a relationship between the measured orientation of the component and a reference orientation associated with the molding assembly, determining, by the control module, an actuation command for operating an actuation arrangement coupled to the tool based at least in part on the orientation adjustment, and providing, by the control module, the actuation command to the actuation arrangement to actuate the tool to rotate the surface in accordance with the orientation adjustment prior to forming a molding compound on an exposed surface of the component using the molding assembly.

In one aspect, the method involves operating an emission source to emit a reference signal within a cavity defined by the molding assembly, wherein obtaining the measurement data involves obtaining a reflected signal from the cavity defined by the molding assembly at the measurement device responsive to the reference signal, wherein a characteristic of the reflected signal is influenced by an orientation of the component with respect to the cavity. In a further aspect, the method determines the measured orientation of the component based at least in part on the characteristic of the reflected signal, wherein determining the orientation adjustment involves determining the orientation adjustment based on the relationship between the measured orientation of the component and the reference orientation associated with the cavity.

In another aspect, obtaining the measurement data involves obtaining image data corresponding to a cavity defined by the molding assembly from the measurement device directed towards the cavity, wherein the image data is influenced by an orientation of the surface of the tool.

In one aspect, the method determines the measured orientation of the component based at least in part on a relationship between the image data and reference image data corresponding to one or more detectable features associated with the cavity.

In another aspect, the method involves operating a second actuation arrangement to close the molding assembly after providing the actuation command to the actuation arrangement to actuate the tool to rotate the surface in accordance with the orientation adjustment and injecting the molding compound into a cavity defined by the molding assembly after closing to form the molding compound on the exposed surface of the component.

In another aspect, after providing the actuation command to the actuation arrangement, the method involves providing a second actuation command to a second actuation arrangement to incrementally close the molding assembly, and thereafter, obtaining updated measurement data from the measurement device indicative of an updated orientation of the component, determining an updated orientation adjustment based on a relationship between the updated orientation of the component and the reference orientation, determining an updated actuation command based at least in part on the updated orientation adjustment, and providing the updated actuation command to the actuation arrangement to actuate the tool to rotate the surface in accordance with the updated orientation adjustment prior to closing the molding assembly.

In another aspect, determining the actuation command involves determining a translational displacement for an end of an arm of the tool resulting in rotational movement of a spherical component mounting structure coupled to an opposing end of the arm corresponding to the orientation adjustment and providing the actuation command involves commanding the actuation arrangement to displace the end of the arm by the translational displacement.

A system is also provided that includes a molding assembly including a first tool having a mounting surface for a component and a second tool defining a cavity for molding the component, an actuation arrangement coupled to the first tool to actuate the first tool to rotate the mounting surface, a measurement device to obtain measurement data indicative of an orientation of the component, and a control module coupled to the actuation arrangement and the measurement device to determine a measured orientation of the component based at least in part on the measurement data, determine an orientation adjustment based on a relationship between the measured orientation of the component and a reference orientation associated with the cavity, determine an actuation command for operating the actuation arrangement based at least in part on the orientation adjustment, and providing the actuation command to the actuation arrangement to actuate the first tool to rotate the mounting surface in accordance with the orientation adjustment prior to injecting a molding compound into the cavity.

In one implementation, the measurement device includes an image sensor or camera adjacent to the molding assembly. In another implementation, the measurement device includes an image sensor or camera integrated with the first tool. In another implementation, the measurement device includes an optical arrangement associated with the component. In another implementation, the control module is coupled to a source associated with the component to command the source to emit a reference signal from the component toward the cavity, wherein the measurement data includes a reflected signal from the cavity responsive to the reference signal, a characteristic of the reflected signal is influenced by the orientation of the component, and the control module is configurable to determine the measured orientation of the component based at least in part on the characteristic of the reflected signal.

In one implementation, the first tool includes a spherical component mounting structure to provide the mounting surface and an arm structure coupled between the spherical component mounting structure and the actuation arrangement, wherein the actuation command causes the actuation arrangement to displace an end of the arm structure to rotate the spherical component mounting structure to rotate the mounting surface in accordance with the orientation adjustment.

A non-transitory computer-readable medium having executable instructions stored thereon that, when executed by a processor, cause the processor to provide an injection molding alignment service configurable to obtain measurement data from a measurement device indicative of a measured orientation of a component mounted to a surface of a tool associated with a molding assembly, determine an orientation adjustment based on a relationship between the measured orientation of the component and a reference orientation associated with the molding assembly, determine an actuation command for operating an actuation arrangement coupled to the tool based at least in part on the orientation adjustment, and provide the actuation command to the actuation arrangement to actuate the tool to rotate the surface in accordance with the orientation adjustment prior to forming a molding compound on an exposed surface of the component using the molding assembly.

In one aspect, the injection molding alignment service is configurable to operate an emission source to emit a reference signal within a cavity defined by the molding assembly, wherein obtaining the measurement data involves obtaining a reflected signal from the cavity defined by the molding assembly at the measurement device responsive to the reference signal, wherein a characteristic of the reflected signal is influenced by an orientation of the component with respect to the cavity. In a further aspect, the injection molding alignment service is configurable to determine the measured orientation of the component based at least in part on the characteristic of the reflected signal, wherein determining the orientation adjustment involves determining the orientation adjustment based on the relationship between the measured orientation of the component and the reference orientation associated with the cavity.

In another aspect, the injection molding alignment service is configurable to obtain image data corresponding to a cavity defined by the molding assembly from the measurement device directed towards the cavity, wherein the image data is influenced by an orientation of the surface of the tool and determine the measured orientation of the component based at least in part on a relationship between the image data and reference image data corresponding to one or more detectable features associated with the cavity.

In another aspect, the injection molding alignment service is configurable to provide a second actuation command to a second actuation arrangement to incrementally close the molding assembly, and thereafter, obtain updated measurement data from the measurement device indicative of an updated orientation of the component, determine an updated orientation adjustment based on a relationship between the updated orientation of the component and the reference orientation, determine an updated actuation command based at least in part on the updated orientation adjustment, and provide the updated actuation command to the actuation arrangement to actuate the tool to rotate the surface in accordance with the updated orientation adjustment prior to closing the molding assembly.

In another aspect, the injection molding alignment service is configurable to determine the actuation command by determining a translational displacement for an end of an arm of the tool resulting in rotational movement of a spherical component mounting structure coupled to an opposing end of the arm corresponding to the orientation adjustment and command the actuation arrangement to displace the end of the arm by the translational displacement.

### BRIEF DESCRIPTION OF THE DRAWINGS

The exemplary aspects will hereinafter be described in conjunction with the following drawing figures, wherein like numerals denote like elements, and wherein:

FIG. 1 is a block diagram illustrating an injection molding system in accordance with various implementations;

FIG. 2 depicts a flow diagram of a molding alignment process suitable for implementation in connection with the injection molding system of FIG. 1 according to one or more implementations described herein;

FIG. 3 is a schematic illustrating a system including a measurement device arranged with respect to an injection molding assembly to obtain measurement data indicative of a relative orientation of a component in connection with the molding alignment process of FIG. 2 in accordance with various implementations;

FIG. 4 depicts a cross-sectional view of an insertion tool suitable for use in the systems of FIG. 1 or FIG. 3 in connection with the molding alignment process of FIG. 2 according to one or more implementations described herein;

FIG. 5 depicts a perspective view of the insertion tool depicted in FIG. 4, where FIG. 4 depicts a cross-section of the insertion tool along the line 4-4 according to one or more implementations described herein;

FIG. 6 depicts a partial cross-sectional view of trench or cutout region circumferentially disposed about the component mounting surface of the insertion tool of FIGS. 4-5 according to one or more implementations described herein; and

FIG. 7 depicts a partial cross-sectional view of an elevated component mounting surface of the insertion tool of FIGS. 4-5 according to one or more implementations described herein.

### DETAILED DESCRIPTION

The following detailed description is merely exemplary in nature and is not intended to limit the application and uses. Furthermore, there is no intention to be bound by any expressed or implied theory presented in the preceding introduction, summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

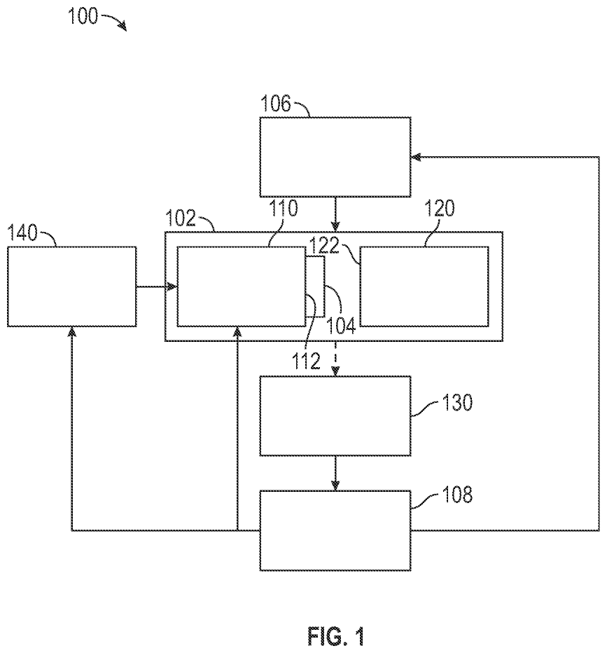

FIG. 1 depicts a layout of an exemplary injection molding system 100 including an injection molding assembly 102 for molding a component 104 mounted to a surface 112 of an insertion tool 110 and disposed between the insertion tool 110 and an injection cavity tool 120. In this regard, the injection molding assembly 102 is associated with an actuation arrangement 106 that is operable under control of a control module 108 to control the position of the respective tools 110, 120 of the injection molding assembly 102 to hermetically seal the component 104 within a cavity defined by the injection cavity tool 120 before injecting a molding compound into the cavity to overmold the component 104.

In the illustrated implementation, a measurement device 130 is configured to sense, detect or otherwise measure the orientation of the component 104 with respect to a reference orientation corresponding to the cavity of the injection cavity tool 120. The measurement device 130 is coupled to the control module 108 to provide data, information or other indicia of the measured or observed orientation of the component 104 to the control module 108. Based on the measured orientation of the component 104 observed by the measurement device 130, the control module 108 controls, commands or otherwise operates an actuation arrangement 140 coupled to the insertion tool 110 to rotate or otherwise adjust the orientation of the mounting surface 112 of the insertion tool 110, and thereby the orientation of the component 104 in relation to the cavity of the injection cavity tool 120 prior to injecting the molding compound into the cavity. By correcting the orientation of the component 104 in relation to the injection cavity tool 120, distortions, deviations or other variations in the thickness or depth of the molding compound overlying the exposed upper surface of the component 104 may be reduced, resulting in a uniform thickness or depth of the molding compound that improves yield and component performance.

Still referring to FIG. 1, the measurement device 130 generally represents any sort of device or element capable of sensing or detecting the position and orientation of an object. For example, the measurement device 130 may include or otherwise be realized as one or more photodetectors, cameras, image sensors, lasers or any other of optical or electrooptical component capable of sensing, detecting, measuring or otherwise observing at least one of the orientation of the component 104, the orientation of the mounting surface 112 of the insertion tool 110 and/or the orientation of the surface 122 of the cavity defined by the injection cavity tool 120 that is facing the exposed surface of the component 104 and/or the mounting surface 112 of the insertion tool 110. In some implementations, the measurement device 130 may be integrated with or otherwise implemented as part of the insertion tool 110 and/or the component 104. In such implementations, the opposing surface 122 of the cavity defined by the injection cavity tool 120 may include one or more detectable features (e.g., shapes, images, patterns, or other target elements) that are detectable or measurable by the measurement device 130 to calibrate and calculate the relative position and orientation of the component 104 and/or the insertion tool 110 in relation to the injection cavity tool 120.

In some implementations, the measurement device 130 may be external to or otherwise distinct and separate from the insertion tool 110 and the component 104 and exposed adjacent to the interface between the respective tools 110, 120 of the injection molding assembly 102 to measure the relative position and orientation of the component 104 disposed between the tools 110, 120 in relation to the surface 122 of the injection cavity tool 120. For example, the measurement device 130 may be realized as a photodetector array or similar optical arrangement that is configurable to measure or otherwise detect signals emitted by the measurement device 130 or one of the tools 110, 120, such as, for example, optical signals or other electromagnetic signals emitted by the measurement device 130 or the insertion tool 110 and reflected off the surface 122 of the injection cavity tool 120, where the angle, intensity, power density, flux, or other characteristics of the reflected signals sensed by the measurement device 130 are indicative of the relative orientation and position of the component 104. For example, in some implementations, the measurement device 130 may be configured to function as a shearing interferometer that measures the angle between the normal vector of the exposed surface of the component 104 and the facing surface 122 of the cavity of the injection cavity tool 120. In various implementations, the surface 122 of the injection cavity tool 120 may include reflective features or elements that may be arranged in a pattern that facilitates accurate derivation of the relative orientation and position of the component 104 based on signal characteristics of the reflected signals and the physical relationship between the position and orientation of the measurement device 130 with respect to the surface 122 of the injection cavity tool 120.

The control module 108 generally represents a computing device or other electronic component that includes at least one processor and data storage element, including, but not limited to, a system on a chip, integrated circuit or another electronics module. The processor can include or be realized as any custom made or commercially available processor, a central processing unit (CPU), a graphics processing unit (GPU), an auxiliary processor among several processors associated with the control module, a semiconductor-based microprocessor (in the form of a microchip or chip set), a macroprocessor, any combination thereof, or generally any device for executing instructions. The data storage element includes or is otherwise realized as a non-transitory computer readable storage device or media, which may include volatile and nonvolatile storage in read-only memory (ROM), random-access memory (RAM), and keep-alive memory (KAM). For example, the data storage element may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the processor. The instructions may include one or more separate programs, each of which includes an ordered listing of executable instructions for implementing logical functions. The instructions, when executed by the processor, cause the processor to support or otherwise provide an injection molding alignment service and perform logic, calculations, methods and/or algorithms for supporting the subject matter described herein.

As described in greater detail below, the injection molding alignment service supported or provided by the control module 108 receives or otherwise obtains measurement data or other information output by the measurement device 130 indicative of the position and orientation of the component 104, and based thereon, calculates or otherwise determines the relative position and orientation of the component 104 to be molded with respect to a reference orientation associated with the injection cavity tool 120. Based on a difference or deviation between the measured orientation of the component 104 and the reference orientation for the injection cavity tool 120, the control module 108 commands, signals or otherwise instructs the actuation arrangement 140 to rotate or otherwise adjust the mounting surface 112 of the insertion tool 110, and thereby, rotationally adjust the orientation of the component 104 to reduce the difference between the measured orientation and the reference orientation. In some implementations, the control module 108 also calculates or otherwise determines a difference or deviation between the measured position of the component 104 and a reference position associated with the injection cavity tool 120 and then commands, signals or otherwise instructs the actuation arrangement 106 to displace, translate or otherwise adjust the mounting surface 112 of the insertion tool 110, and thereby, translationally adjust the position of the component 104 to reduce the difference between the measured position and the reference position. In this manner, the control module 108 can control the relative position and orientation of the component 104 with six degrees of freedom (6DOF) in relation to the cavity surface 122 of the injection cavity tool 120 to achieve uniform molding of the component 104.

In one or more implementations, the control module 108 is configurable to dynamically and iteratively adjust the orientation of the component 104 as the actuation arrangement 106 is operated to close the injection molding assembly 102 (e.g., by translationally displacing the insertion tool 110 towards the injection cavity tool 120 until the tools 110, 120 mate or otherwise engage one another). In this regard, as the distance between the tools 110, 120 decreases, the control module 108 may dynamically adjust the orientation and/or position of the component 104 by operating one or more actuation arrangements 106, 140 to produce a corresponding adjustment to at least one of the tools 110, 120, thereby minimizing any deviations or differences between the final position and orientation of the component 104 and the reference position and orientation of the cavity defined by the injection cavity tool 120 once the tools 110, 120 are closed.

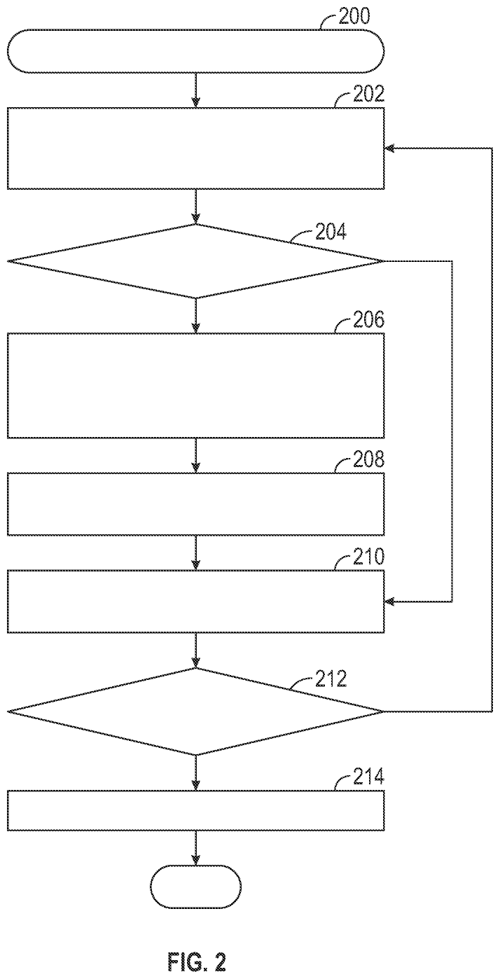

FIG. 2 depicts an exemplary implementation of a molding alignment process 200 that may be implemented or otherwise performed by an injection molding alignment service at a control module to align a component within an injection molding cavity prior to molding (e.g., injection molding, overmolding, or the like) and perform additional tasks, functions, and/or operations described herein. For illustrative purposes, the following description may refer to elements mentioned above in connection with FIG. 1. While portions of the molding alignment process 200 may be performed by different elements of a vehicle system, for purposes of explanation, the subject matter may be primarily described herein in the context of the molding alignment process 200 being primarily performed by the control module 108 that is coupled to the measurement device 130 and controls operation of the tools 110, 120 of the injection molding assembly 102 via actuation arrangements 106, 140.

Referring to FIG. 2 with continued reference to FIG. 1, the molding alignment process 200 initializes or begins by receiving or otherwise obtaining measurement data indicative of the relative orientation and position of a component that is mounted to an insertion tool at 202 and verifying or otherwise determining whether the measured orientation and position satisfies one or more alignment criteria in relation to an injection cavity tool at 204. In this regard, after a component 104 to be molded is mounted or otherwise affixed to the surface 112 of the insertion tool 110 (e.g., by inserting one or more pins on one of the component 104 or the mounting surface 112 into corresponding interfaces on the other one of the component 104 or the mounting surface 112), the injection molding alignment service at the control module 108 obtains measurement data from the measurement device 130 that indicates the relative orientation and position of the component 104 in relation to the facing surface 122 of the cavity of the injection cavity tool 120.

For example, in one implementation, the measurement device 130 is realized as a camera or other sensor integrated with the insertion tool 110 and/or the component 104 that is capable of detecting or otherwise sensing one or more features or characteristics associated with the cavity surface 122 and provides corresponding image data or other measurement data to the control module 108 from which the control module 108 can calculate, derive or otherwise determine the relative orientation and position of the component 104. For example, the cavity surface 122 may include a calibrated pattern of detectable features or characteristics that defines expected reference image data for when a camera or other sensor integrated with the insertion tool 110 and/or the component 104 is substantially aligned parallel to the cavity surface 122 or another reference orientation associated with the cavity, where the control module 108 can calculate, derive or otherwise determine the relative orientation and position of the component 104 based on the relationship between the captured image data and the expected reference image data corresponding to the detectable features or characteristics associated with the cavity surface 122. In other implementations, the molding alignment service at the control module 108 commands a source of optical or electromagnetic signals associated with one of the insertion tool 110, the component 104 and/or the measurement device 130 to generate, emit or otherwise direct reference signals towards the injection cavity tool 120, where the measurement device 130 detects, senses or otherwise receives reflected signals from the cavity surface 122 resulting from reflection of the reference signals by the cavity surface 122. Based on the relationship between signal characteristics of the reflected signals and the emitted reference signal, the molding alignment service at the control module 108 can calculate, derive or otherwise determine the relative orientation and position of the component 104 with respect to the cavity surface 122.

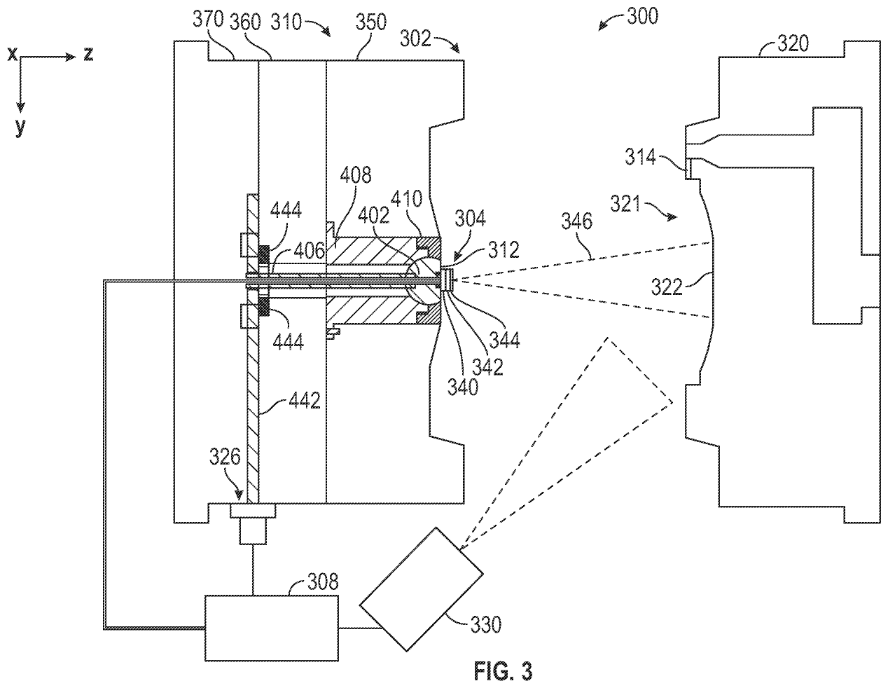

FIG. 3 depicts an exemplary system 300 for obtaining measurement data indicative of the relative orientation and alignment of a component 304 (e.g., component 104) disposed on a mounting surface 312 (e.g., mounting surface 112) of an insertion tool 310 (e.g., insertion tool 110) configured to mate or otherwise engage with a cavity 321 defined by an injection cavity tool 320 (e.g., injection cavity tool 120) as part of an injection molding assembly 302 (e.g., injection molding assembly 102). In the illustrated example, the component 304 is realized as an optical device that includes an electronics substrate 340 (e.g., a printed circuit board) having a bottom surface that is mounted to the surface 312 of the insertion tool 310. The opposing surface of the substrate 340 includes one or more emission sources 342 capable of directing or otherwise generating reference electromagnetic signals 346 directed towards the cavity surface 322, such as, for example, an array of light emitting diodes (LEDs), vertical-cavity surface-emitting lasers (VCSELs), or another suitable source of electromagnetic radiation. The illustrated component 304 also includes an optics arrangement 344 including one or more optical elements or components on or overlying the electromagnetic emission source 342, such as, for example, one or more lenses (e.g., a microlens array), a waveguide, a beam shaper, or the like.

A control module 308 (e.g., control module 108) is coupled to the emission source 342 (e.g., via interconnection through the electronics substrate 340 when coupled to the control module 308) and transmits or otherwise provides excitation signals, commands or other instructions that are configurable to cause the emission source 342 to generate the desired reference signals 346 directed towards the cavity surface 322. A measurement device 330 (e.g., measurement device 130) is disposed or otherwise arranged proximate the interface between the tools 310, 320 and oriented to capture, detect or otherwise sense reflected signals from the cavity surface 322 resulting from the incident reference signals 346. The measurement device 330 is coupled to the control module 308 to provide corresponding measurement data indicative of one or more signal characteristics of the reflected signals. Based on the relationship between the signal characteristics of the reflected signals and the corresponding signal characteristics of the reference signals 346, the control module 308 calculates or otherwise determines the relative orientation of the component 304 (e.g., the exposed surface of the optical arrangement 344) with respect to the cavity surface 322 (e.g., an angular or rotational difference between the surfaces). Additionally, the control module 308 may calculate or otherwise determine a relative position of component 304 with respect to the cavity surface 322 (e.g., a translational difference between geometric centers of the component 304 and the cavity surface 322).

Referring again to FIG. 2 with continued reference to FIGS. 1 and 3, in exemplary implementations, the molding alignment process 200 is configured to support 6DOF alignment of the component with respect to the injection molding cavity, where at 204, the injection molding alignment service verifies that the angular difference between the orientation of the component and the orientation of the injection molding cavity surface is less than a threshold angular difference while also verifying that the translational difference between the geometric center or other reference point associated with the component and a corresponding reference point associated with the injection molding cavity surface is less than a threshold translational difference. When the angular difference between the orientation of the component and the reference orientation of the injection molding cavity surface is greater than a threshold angular difference and/or the translational difference between the component and the injection molding cavity surface is greater than a threshold translational difference, the molding alignment process 200 determines the alignment criteria are not satisfied at 204.

Still referring to FIG. 2, when the alignment criteria are not satisfied, the molding alignment process 200 calculates or otherwise determines commands for adjusting the orientation and/or position of the insertion tool to correct the orientation and/or position of the component to satisfy the alignment criteria based on the relative orientation and/or position of the component at 206. In this regard, based on the angular difference between the measured orientation of the component 104, 304 derived from the measurement data and the reference orientation defined by the cavity surface 122, 322, the molding alignment service at the control module 108, 308 calculates or otherwise determines one or more commands for operating the actuation arrangement 140 to adjust the orientation of the insertion tool 110, 310 and/or the mounting surface 112, 312 to thereby reduce the angular difference between the orientation of the component 104, 304 and the orientation defined by the cavity surface 122, 322 to within the threshold angular difference (or angular alignment threshold). Similarly, based on the translational difference between the measured position of the component 104, 304 derived from the measurement data and the reference position for the cavity 321 defined by the injection cavity tool 120, 320, the molding alignment service at the control module 108, 308 calculates or otherwise determines one or more commands for operating an actuation arrangement 106, 326 to adjust the translational position of at least one of the insertion tool 110, 310 and/or the injection cavity tool 120, 320 to thereby reduce the translational difference to within the threshold translational difference (or translational alignment threshold).

After determining commands for adjusting the orientation and/or position of the component at 206, the molding alignment process 200 operates the actuation arrangement(s) to produce corresponding adjustments to the orientation and/or position of the insertion tool relative to the injection cavity tool at 208 prior to operating an actuation arrangement to close the injection molding assembly at 210. In this regard, the control module 108, 308 commands, signals or otherwise operates the actuation arrangement 140, 326 to adjust the orientation of the mounting surface 112, 312, and thereby, corrects or otherwise adjusts the orientation of the component 104, 304 with respect to the cavity surface 122, 322. In a similar manner, the control module 108, 308 may command, signal or otherwise operate the actuation arrangement 106, 326 to adjust the relative positions of the tools 110, 120, 310, 320, and thereby, correct or otherwise adjust the position of the component 104, 304 with respect to the cavity surface 122, 322. After performing any 6DOF alignment adjustments, the control module 108, 308 may command, signal or otherwise operate the actuation arrangement 106, 326 to translationally displace or otherwise advance the insertion tool 110, 310 towards the injection cavity tool 120, 320.

Still referring to FIG. 2, in exemplary implementations, the molding alignment process 200 incrementally closes the injection molding assembly and continually monitors the relative position of the tools of the injection molding assembly to detect or otherwise identify when the injection molding assembly is closed at 212. In this regard, prior to the injection molding assembly becoming closed, in exemplary implementations, the loop defined by 202, 204, 206, 208, 210 and 212 is continually repeated to incrementally and dynamically perform 6DOF alignment adjustments while incrementally closing the injection molding assembly to minimize any variations in alignment between the component and the cavity surface. Once the injection molding assembly is closed (e.g., when translational displacement of the insertion tool 110, 310 towards the injection cavity tool 120, 320 is no longer possible), the molding alignment process 200 automatically initiates injection of a molding compound into the cavity defined by the injection cavity tool to overmold the component at 214. For example, as shown in FIG. 3, one or more nozzles 314 may be integrated with the cavity tool 320 and operable to inject a molding compound into the cavity 321 in response to corresponding commands, instructions or other signals from the control module 308. In this regard, once the insertion tool 310 and the injection cavity tool 320 are closed to hermetically seal the cavity 321 between the tools 310, 320, the control module 308 may automatically command or otherwise operate the nozzles 314 of the cavity tool 320 to inject molding compound into the cavity 321, and thereby, overmold the component 304. In this regard, by virtue of the 6DOF alignment of the surface of the component 304 with the facing cavity surface 322, the resulting layer of molding compound overlying the optical arrangement 344 may be substantially uniform and consistent in thickness across the surface of the optical arrangement 344, thereby increasing the likelihood of consistent performance across different instances of the component 304.

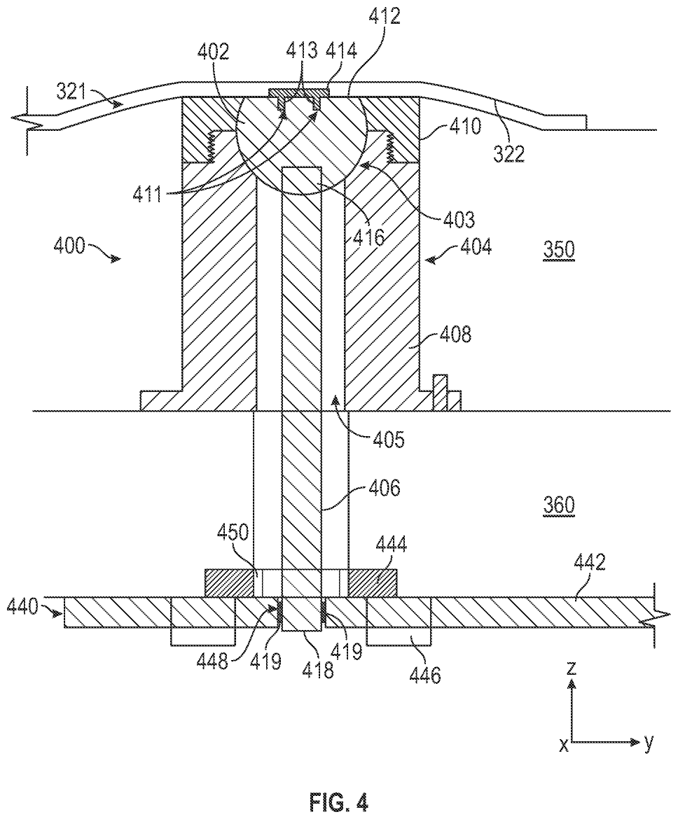

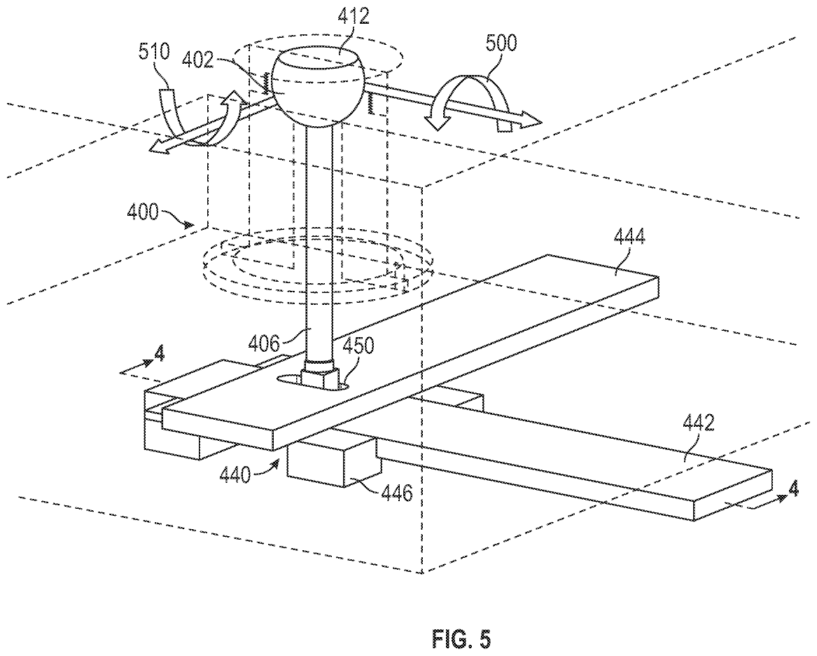

FIGS. 4-5 depict an exemplary implementation of an insertion tool 400 suitable for use as an insertion tool 110, 310 and an associated actuation arrangement 440 suitable for use as the actuation arrangement 140, 326 in connection with FIGS. 1-3. The insertion tool 400 includes a truncated spherical component mounting structure 402 disposed within a corresponding void or recess 403 in a housing 404 that allows the component mounting structure 402 to freely rotate in two different planes (e.g., about the x and y reference axes) with respect to the housing 404 while the housing 404 prevents translational displacement of the component mounting structure 402 with respect to the housing 404, similar to a ball joint. In this regard, the housing 404 includes a central voided region 405 to accommodate an arm structure 406 having an end proximal the component mounting structure 402 that is fixedly engaged with the component mounting structure 402 such that the central longitudinal axis of the arm structure 406 is substantially aligned parallel to a central axis of the component mounting structure 402. The distal end of the arm structure 406 is engaged with or otherwise coupled to the actuation arrangement 440, such that actuation of the actuation arrangement 440 causes displacement of the proximal end of the arm structure 406, which, in turn, results in rotational movement of the component mounting structure 402 by virtue of the arm structure 406 and the component mounting structure 402 being comprised of substantially rigid material.

In the implementation depicted in FIG. 4, the truncated portion of the spherical component mounting structure 402 defines the substantially planar component mounting surface 412 which includes voids or recessed regions 411 that are configured to receive and engage corresponding mounting pins 413 associated with the component 414 (e.g., component 104, 304) to be molded. The spherical recess 403 of the housing 404 substantially conforms to the spherical outer surface of the component mounting structure 402 to establish a seal that prevents molding compound injected into the cavity from entering the voided region 405 due to backpressure while still allowing the component mounting structure 402 to rotate with respect to the housing 404. In the illustrated implementation, the housing 404 is realized as a two part housing including a substantially cylindrical base portion 408 of rigid material having a hollow interior defining the central arm recessed region 405 and a first portion of the spherical recess 403 and an annular cap portion 410 of rigid material that is fixedly engaged with the base portion 408 to define the remaining portion of the spherical recess 403 and restrict translational movement of the component mounting structure 402. For example, in the implementation depicted in FIG. 4, the cap portion 410 includes internal threads that are threaded or screwed onto corresponding external threads on the proximal end of the base portion 408. Although not illustrated in FIG. 4, in practice, one or more nozzles (e.g., nozzles 314) may be integrated with or otherwise contained within the housing 404 and operable under control of a control module to inject molding compound into a cavity opposite the insertion tool 400 (e.g., via ports or outlets formed in the cap portion 410 about the component mounting structure 402).

The arm structure 406 is realized as a rigid material having a length that is greater than a length of the base portion 408 such that a portion of the arm structure 406 distal to the mounting structure 402 extends beyond the base portion 408 by some distance until reaching the actuation arrangement 440. In one or more implementations, the proximal end 416 of the arm structure 406 is fixedly engaged with the mounting structure 402, for example, by inserting the proximal end 416 into a corresponding void or recess of the mounting structure 402 and adhering or affixing the proximal end 416 to the mounting structure 402. In some implementations, the proximal end 416 of the arm structure 406 includes external threads that are threaded or screwed onto corresponding internal threads of the corresponding void or recess of the mounting structure 402. The distal end 418 of the arm structure 406 includes a cam feature 419 that rotatably engages the distal end 418 of the arm structure 406 to the actuation arrangement 440 and translates linear movement of the actuation arrangement 440 into rotational motion of the arm structure 406 that correspondingly rotates the mounting structure 402 with respect to the housing 404.

In exemplary implementations, the actuation arrangement 440 is realized as a pair of linear actuators including a first linkage arm 442 actuatable in a first direction (e.g., the y-axis reference direction) and a second linkage arm 444 actuatable in a different direction (e.g., the x-axis reference direction) that is orthogonal to that of the first linkage arm 442. In this regard, the linkage arms 442, 444 may be arranged orthogonal to one another. In exemplary implementations, the lower linkage arm 442 is realized as a substantially planar rigid structure disposed within a corresponding voided or cutout region of a rigid bracket structure 446 that contacts or otherwise engages the lower linkage arm 442 restricts movement of the lower linkage arm 442 in directions that are orthogonal to the actuatable direction of the lower linkage arm 442. In other words, the bracket structure 446 prevents displacement of the lower linkage arm 442 in the x-axis or z-axis reference directions. As a result, actuation or translational displacement of the upper linkage arm 444 in the x-axis direction is translated into rotational movement of the arm structure 406 without producing corresponding actuation or translational displacement of the lower linkage arm 442 in the x-axis direction, resulting in rotational movement of the mounting structure 402 about the y-axis within the xz-reference plane indicated by arrow 500, as described in greater detail below.

In exemplary implementations, the lower linkage arm 442 includes a voided or cutout region 448 that receives and circumscribes the distal end 418 of the arm structure 406 and rotatably engages the cam feature 419 of the arm structure 406. By virtue of the bracket 446 preventing translational displacement of the lower linkage arm 442 within the xz-reference plane, actuation or translational displacement of the lower linkage arm 442 in the y-axis reference direction results in rotational movement of the mounting structure 402 about the x-axis within the yz-reference plane indicated by arrow 510 via the translational displacement of the distal end 418 of the arm structure 406 and corresponding rotational movement of the arm structure 406 via the cam feature 419 and spherical recess 403. In this regard, the upper linkage arm 444 includes a substantially oval-shaped voided or cutout region 450 that circumscribes the arm structure 406, with the longitudinal dimension (or longitudinal axis) of the oval cutout region 450 being aligned in the y-axis direction corresponding to the actuatable direction of the lower linkage arm 442, such that the upper linkage arm 444 does not inhibit actuation of the lower linkage arm 442 or corresponding rotational movement 510 of the mounting structure in the yz-reference plane. That said, when the upper linkage arm 444 is actuated in the x-axis reference direction, the inner surface of the cutout region 450 contacts the arm structure 406 to produce corresponding displacement of the arm structure 406 in the x-axis reference direction, which, in turn, results in rotational movement 500 of the mounting structure 402 within the xz-reference plan by virtue of the cam feature 419 and spherical recess 403 accommodating rotational movement of the arm structure 406. In exemplary implementations, each of the linkage arms 442, 444 is mechanically coupled to a motor or other actuator capable of causing translational displacement of the respective linkage arm 442, 444 in its respective actuatable direction. In this regard, the motors or other actuators associated with the actuation arrangement 440 are coupled to a control module (e.g., control module 108, 308) to receive commands or other instructions for displacing the respective linkage arm 442, 444 by a commanded amount of translational displacement that produces a desired amount of rotational adjustment to the orientation of the mounting surface 412 of the component mounting structure 402. In practice, the control module may be coupled to one or more encoders or other position feedback sensors coupled to a respective one of the linkage arms 442, 444, motors or other actuators associated with the actuation arrangement 440 to provide precise and accurate real-time position data indicative of the relative position of the distal end 418 of the arm structure 406, and thereby, enable the control module to precisely and accurately control the position of the distal end 418 of the arm structure 406, which, in turn, enables precise and accurate control of the orientation of the component mounting structure 402.

Referring to FIGS. 1-5, by using the insertion tool 400 as the insertion tool 110, 310 in the context of the molding alignment process 200, the injection molding alignment service at the control module 108, 308 can control the roll, pitch and yaw of the component mounting surface 112, 312, 412 (e.g., 3DOF rotational control) via the actuation arrangement 140, 440. At the same time, the control module 108, 308 can achieve three-dimensional translational control of the insertion tool 110, 310, 400 using another actuation arrangement 106, 326 operable to control the relative position of the insertion tool 110, 310, 400 in the x, y and z directions, thereby providing combined 6DOF control of the component mounting surface 112, 312, 412 and the component 104, 304, 414 disposed thereon in relation to the injection cavity tool 120, 320. In this regard, the housing 404 and the bracket structure 446 that retain the component mounting structure 402, the arm structure 406 and the actuation linkages 442, 444 may be mounted to or otherwise supported by one or more plates or other rigid structures that may be coupled to or otherwise joined to the actuation arrangement 106, 326 that is operable to control the translational position of the insertion tool 400. By virtue of the 6DOF control of the component 104, 304, 414, the molding alignment process 200 enables uniform depth and thickness of the resulting molding compound formed on or overlying the exposed surface of the component 104, 304, 414, thereby ensuring uniform performance of the component 104, 304, 414 across different instances of molding and improving component yields.

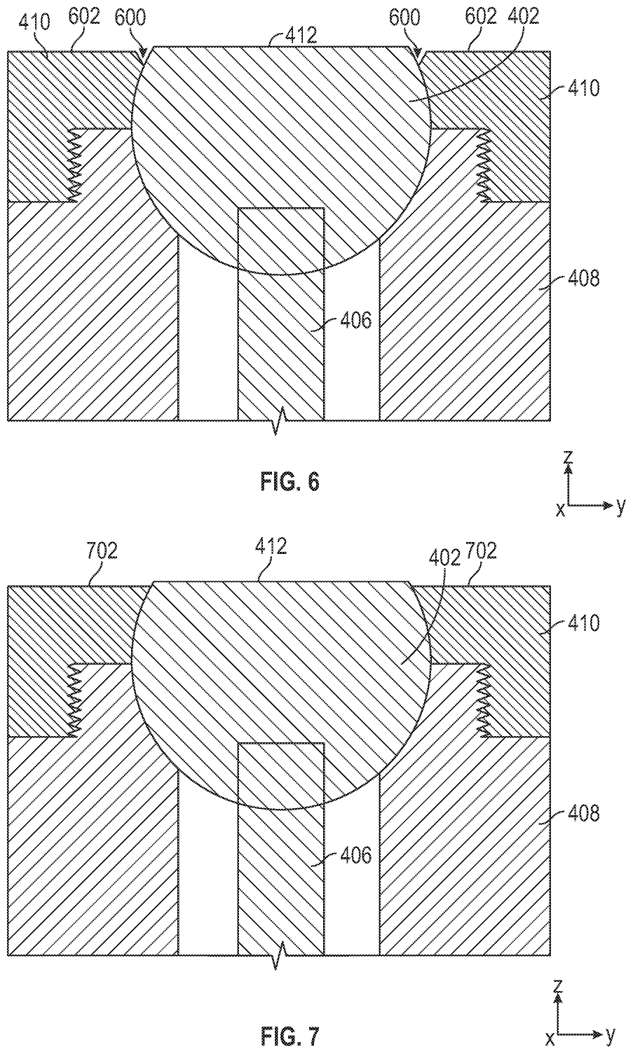

FIG. 6 depicts an exemplary implementation of an insertion tool that includes a voided trench or cutout region 600 circumferentially disposed about the component mounting surface 412 of the component mounting structure 402 between the component mounting structure 402 and the surface 602 of the cap portion 410 of the housing 404. The component mounting surface 412 and the upper surface 602 of the housing 404 may be substantially aligned within the same plane when in a neutral or reference position (e.g., when the arm structure 406 is aligned parallel with the z-axis), with the trench cutout region 600 surrounding the component mounting surface 412 to provide topological relief that prevents the formation of knife edge or undercut portions of molding compound when the component mounting surface 412 is rotated such that the plane defined by the component mounting surface 412 is off axis or unaligned with the plane defined by the upper surface 602 of the housing 404. In this regard, eliminating knife edge or undercut portions of molding compound enables the component 104, 304, 414 to be more readily ejected from the component mounting surface 112, 312, 412 after molding without impairing the structural integrity of the molding compound formed on the component 104, 304, 414 or the component 104, 304, 414 itself.

FIG. 7 depicts another implementation of an insertion tool that includes a component mounting surface 412 of the component mounting structure 402 that is elevated relative to the surface 702 of the cap portion 410 of the housing 404 when in a neutral or reference position (e.g., when the arm structure 406 is aligned parallel with the z-axis). By virtue of the recessed housing surface 702 (or elevated component mounting surface 412), the implementation in FIG. 7 similarly prevents formation of portions of molding compound at or along the interface between the component mounting structure 402 and the surrounding cap portion 410 of the housing 404 that could inhibit ejection of the component 104, 304, 414 from the insertion tool after molding.

Referring to FIGS. 4-7 with continued reference to FIGS. 1-3, in one or more implementations, the component mounting surface 112, 312, 412 and/or the component mounting structure 402 includes or otherwise incorporates one or more heat sinks or other cooling components to mitigate heating of the component 104, 304, 414 during molding. For example, a thermoelectric cooler (TEC) could be integrated into the component mounting structure 402 and/or the component mounting surface 412 to transfer heat from the component 104, 304, 414 to the remainder of the component mounting structure 402 and/or the housing 404.

Referring again to FIG. 3 with continued reference to FIGS. 4-7, in exemplary implementations, the insertion tool 400 is disposed within the hollow interior of an outer housing structure 350 of a rigid material that interfaces or mates with the cavity tool 320 to define the injection molding cavity. The outer housing structure 350 is mounted to or otherwise supported by a substantially planar support plate structure 360 of rigid material that prevents relative displacement of the insertion tool 400 in the negative z-direction while the outer housing structure 350 prevents relative displacement of the insertion tool 400 in the z-direction. The support plate structure 360 is mounted to, affixed to, or otherwise disposed within an ejector housing structure 370 that includes, contains or otherwise supports an ejection system configurable to receive or remove the component 304 from the mounting surface 312 after molding. As illustrated in FIG. 3, in some implementations, the spherical mounting structure 402 and the arm structure 406 may include a hollow interior or voided region for routing wires or cables between the control module 308 and corresponding input/output (I/O) interfaces on or otherwise associated with the mounting surface 312 or ejector pins to establish an electrical connection between the component 304 and the control module 308 for purposes of operating the component 304 to emit the electromagnetic signals 346.

By virtue of the subject matter described herein, accurate, precise and uniform molded components may be manufactured by being able to accurately and precisely align individual components in 6DOF with respect to molding cavity and/or the molding tools to control the orientation as well as the position of individual components prior to molding. Uniformly molding individual components improves performance and yield by reducing the number of molded components that are out of specification, thereby reducing costs and waste.

For sake of brevity, conventional techniques related to injection molding, overmolding, semiconductor device fabrication and/or packaging, component manufacturing, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an implementation of the subject matter.

As used herein, the word “exemplary” means “serving as an example, instance, or illustration.” Thus, any implementation described herein as “exemplary” is not necessarily to be construed as preferred or advantageous over other implementations. All of the implementations described herein are exemplary implementations provided to enable persons skilled in the art to make or use the invention and not to limit the scope of the invention which is defined by the claims.

Those of skill in the art will appreciate that the various illustrative logical blocks, modules, circuits, and algorithm steps described in connection with the implementations disclosed herein may be implemented as electronic hardware, computer software, or combinations of both. Some of the implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is logically coherent.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing the exemplary aspect or exemplary aspects. It should be understood that various changes can be made in the function and arrangement of elements without departing from the scope of the disclosure as set forth in the appended claims and the legal equivalents thereof.

What is claimed is:

1. A method comprising:
obtaining, by a control module, measurement data from a measurement device indicative of a measured orientation of a component mounted to a surface of a tool associated with a molding assembly;
determining, by the control module, an orientation adjustment based on a relationship between the measured orientation of the component and a reference orientation associated with the molding assembly;
determining, by the control module, an actuation command for operating an actuation arrangement coupled to the tool based at least in part on the orientation adjustment; and
providing, by the control module, the actuation command to the actuation arrangement to actuate the tool to rotate the surface in accordance with the orientation adjustment prior to forming a molding compound on an exposed surface of the component using the molding assembly.

2. The method of claim 1, further comprising operating an emission source to emit a reference signal within a cavity defined by the molding assembly, wherein obtaining the measurement data comprises obtaining a reflected signal from the cavity defined by the molding assembly at the measurement device responsive to the reference signal, wherein a characteristic of the reflected signal is influenced by an orientation of the component with respect to the cavity.

3. The method of claim 2, further comprising determining the measured orientation of the component based at least in part on the characteristic of the reflected signal, wherein determining the orientation adjustment comprises determining the orientation adjustment based on the relationship between the measured orientation of the component and the reference orientation associated with the cavity.

4. The method of claim 1, wherein obtaining the measurement data comprises obtaining image data corresponding to a cavity defined by the molding assembly from the measurement device directed towards the cavity, wherein the image data is influenced by an orientation of the surface of the tool.

5. The method of claim 4, further comprising determining the measured orientation of the component based at least in part on a relationship between the image data and reference image data corresponding to one or more detectable features associated with the cavity.

6. The method of claim 1, further comprising:
operating a second actuation arrangement to close the molding assembly after providing the actuation command to the actuation arrangement to actuate the tool to rotate the surface in accordance with the orientation adjustment; and
injecting the molding compound into a cavity defined by the molding assembly after closing to form the molding compound on the exposed surface of the component.

7. The method of claim 1, further comprising, after providing the actuation command to the actuation arrangement:
providing a second actuation command to a second actuation arrangement to incrementally close the molding assembly; and
thereafter:
obtaining updated measurement data from the measurement device indicative of an updated orientation of the component;
determining an updated orientation adjustment based on a relationship between the updated orientation of the component and the reference orientation;
determining an updated actuation command based at least in part on the updated orientation adjustment; and
providing the updated actuation command to the actuation arrangement to actuate the tool to rotate the surface in accordance with the updated orientation adjustment prior to closing the molding assembly.

8. The method of claim 1, wherein:
determining the actuation command comprises determining a translational displacement for an end of an arm of the tool resulting in rotational movement of a spherical component mounting structure coupled to an opposing end of the arm corresponding to the orientation adjustment; and
providing the actuation command comprises commanding the actuation arrangement to displace the end of the arm by the translational displacement.

9. A system comprising:
a molding assembly including a first tool having a mounting surface for a component and a second tool defining a cavity for molding the component;
an actuation arrangement coupled to the first tool to actuate the first tool to rotate the mounting surface;
a measurement device to obtain measurement data indicative of an orientation of the component; and
a control module coupled to the actuation arrangement and the measurement device to:
determine a measured orientation of the component based at least in part on the measurement data;
determine an orientation adjustment based on a relationship between the measured orientation of the component and a reference orientation associated with the cavity;
determine an actuation command for operating the actuation arrangement based at least in part on the orientation adjustment; and
providing the actuation command to the actuation arrangement to actuate the first tool to rotate the mounting surface in accordance with the orientation adjustment prior to injecting a molding compound into the cavity.

10. The system of claim 9, wherein the measurement device comprises an image sensor or camera adjacent to the molding assembly.

11. The system of claim 9, wherein the measurement device comprises an image sensor or camera integrated with the first tool.

12. The system of claim 9, wherein the measurement device comprises an optical arrangement associated with the component.

13. The system of claim 9, wherein the control module is coupled to a source associated with the component to command the source to emit a reference signal from the component toward the cavity, wherein:
the measurement data comprises a reflected signal from the cavity responsive to the reference signal;
a characteristic of the reflected signal is influenced by the orientation of the component; and
the control module is configured to determine the measured orientation of the component based at least in part on the characteristic of the reflected signal.

14. The system of claim 9, wherein the first tool comprises a spherical component mounting structure to provide the mounting surface and an arm structure coupled between the spherical component mounting structure and the actuation arrangement, wherein the actuation command causes the actuation arrangement to displace an end of the arm structure to rotate the spherical component mounting structure to rotate the mounting surface in accordance with the orientation adjustment.

15. A non-transitory computer-readable medium comprising executable instructions that, when executed by a processor, cause the processor to provide an injection molding alignment service configurable to:
obtain measurement data from a measurement device indicative of a measured orientation of a component mounted to a surface of a tool associated with a molding assembly;
determine an orientation adjustment based on a relationship between the measured orientation of the component and a reference orientation associated with the molding assembly;
determine an actuation command for operating an actuation arrangement coupled to the tool based at least in part on the orientation adjustment; and
provide the actuation command to the actuation arrangement to actuate the tool to rotate the surface in accordance with the orientation adjustment prior to forming a molding compound on an exposed surface of the component using the molding assembly.

16. The non-transitory computer-readable medium of claim 15, wherein the injection molding alignment service is configurable to operate an emission source to emit a reference signal within a cavity defined by the molding assembly, wherein obtaining the measurement data comprises obtaining a reflected signal from the cavity defined by the molding assembly at the measurement device responsive to the reference signal, wherein a characteristic of the reflected signal is influenced by an orientation of the component with respect to the cavity.

17. The non-transitory computer-readable medium of claim 16, wherein the injection molding alignment service is configurable to determine the measured orientation of the component based at least in part on the characteristic of the reflected signal, wherein determining the orientation adjustment comprises determining the orientation adjustment based on the relationship between the measured orientation of the component and the reference orientation associated with the cavity.

18. The non-transitory computer-readable medium of claim 15, wherein the injection molding alignment service is configurable to:
obtain image data corresponding to a cavity defined by the molding assembly from the measurement device directed towards the cavity, wherein the image data is influenced by an orientation of the surface of the tool; and
determine the measured orientation of the component based at least in part on a relationship between the image data and reference image data corresponding to one or more detectable features associated with the cavity.

19. The non-transitory computer-readable medium of claim 15, wherein the injection molding alignment service is configurable to:
provide a second actuation command to a second actuation arrangement to incrementally close the molding assembly; and
thereafter:
obtain updated measurement data from the measurement device indicative of an updated orientation of the component;
determine an updated orientation adjustment based on a relationship between the updated orientation of the component and the reference orientation;
determine an updated actuation command based at least in part on the updated orientation adjustment; and
provide the updated actuation command to the actuation arrangement to actuate the tool to rotate the surface in accordance with the updated orientation adjustment prior to closing the molding assembly.

20. The non-transitory computer-readable medium of claim 15, wherein the injection molding alignment service is configurable to:
determine the actuation command by determining a translational displacement for an end of an arm of the tool resulting in rotational movement of a spherical component mounting structure coupled to an opposing end of the arm corresponding to the orientation adjustment; and
command the actuation arrangement to displace the end of the arm by the translational displacement.
